(19) United States
(12) Patent Application Publication
(10) Pub. No.: US 2006/0117574 A1
(43) Pub. Date: Jun. 8, 2006

(54) Wallboard cutting tool

(76) Inventor: Brian Martin, Commerce, GA (US)

Correspondence Address: LITMAN LAW OFFICES, LTD, PO BOX 15035, CRYSTAL CITY STATION, ARLINGTON, VA, 22215, US

(21) Appl. No.: 11/280,396

(22) Filed: Nov. 17, 2005

Related U.S. Application Data
(60) Provisional application No. 60/633,722, filed on Dec. 7, 2004.

(51) Int. Cl. B26B 29/00

(52) U.S. Cl. 30/294

(57) ABSTRACT

The wallboard cutting tool is a compact, handheld device providing a very accurate first cut through the first surface of a sheet of wallboard material normal to a reference edge of the sheet, without additional aids, such as chalk lines, squares, etc. This is accomplished by a truing lip, which is used to true the device normal to the edge of the wallboard, and a pair of rollers that are rotationally fixed to one another. The relatively fixed rollers assure that the device cannot turn to any significant degree while being drawn across the wallboard sheet, thus assuring a straight line cut. A second blade is provided on the end of the tool opposite the first blade for cutting the backing paper opposite the first cut to complete the job. A supplemental retractable tape and/or belt hanger passage may also be provided with the device.

### CROSS-REFERENCE TO RELATED APPLICATION

This application claims the benefit of U.S. Provisional Patent Application Ser. No. 60/633,722, filed Dec. 7, 2004.

### BACKGROUND OF THE INVENTION

1. Field of the Invention

The present invention relates generally to hand tools. More specifically, the wallboard cutting tool is configured especially for cutting gypsum wallboard, also known as drywall and sheetrock® (sheetrock is a registered trademark of United States Gypsum Company).

2. Description of the Related Art

Gypsum wallboard, or drywall or sheetrock as it is known in the trade, is nearly universally used to finish interior walls and ceilings in building structures. The material is formed of a firm compressed gypsum core with a relatively thin sheet of construction paper applied to each side. The paper adds significant resistance to the sheet against bending and breaking, due to the inelastic nature of the paper. As a result, the customary means used to cut standard size gypsum wallboard panels to a smaller size is to cut through the paper on one side of the board while simultaneously scoring the gypsum core. The core easily breaks along the score line, flexing along the uncut paper opposite the cut. The uncut paper is then cut through along the crease line to complete the cutting of the wallboard sheet.

Obviously, it is necessary to provide a reasonably accurate cut, i.e., a cut that drifts from a theoretically perfect line by only a fraction of an inch or so in the length of a panel, which can be up to twelve feet in length. If the cut drifts by much more than a large fraction of an inch, the resulting gap between panels or along a corner junction is too large to bridge with seam paper and drywall compound. While such a gap can be filled with a smaller sliver of wallboard, the time and labor required for such a repair can add significantly to the cost of the job if more than a few such repairs are required.

A number of different devices have been developed in the past to carry out a reasonably straight cut along or across a sheet of wallboard. The problem with most such tools is that when they are constructed to a relatively small size for ease of handling and storage, they lack the straight line accuracy in making a cut on a sheet of wallboard without requiring some additional aid, e.g., a steel tape, square, chalk line, etc. Some larger tools can provide sufficient accuracy, but include integral squares and the like, which results in relatively bulky devices that are difficult to transport and store.

The present inventor is aware of certain devices belonging to the general family of tools noted above. An example of such is found in German Patent Publication No. 19,827,703, published on Dec. 23, 2000. According to the drawings and English abstract, this device includes a guide that slides along one edge of the wallboard and a cutting wheel extending from the end of an elongate connecting arm, which, in turn, extends from the guide. Another example of such a tool is found in German Patent Publication No. 19,900,248, published on Mar. 9, 2000. According to the drawings and English abstract, this device also includes an elongate arm having a cutting tool at the distal end thereof.

None of the above inventions and patents, taken either singly or in combination, is seen to describe the instant invention as claimed. Thus, a wallboard cutting tool solving the aforementioned problems is desired.

### SUMMARY OF THE INVENTION

The wallboard cutting tool is a relatively small, handheld device that fits within the palm and extended fingers of the hand. The device includes a retractable first cutting blade extending from one end thereof, with a truing lip extending across the end normal to the blade. A pair of lateral rollers is also provided, with the rollers having a single axle normal to the plane of the cutting blade and parallel to the truing lip. The two rollers are rotationally affixed to one another, i.e., rotation of one roller forces the opposite roller to rotate at the same rotational speed and direction.

The device is used by truing the blade normal to an edge of the wallboard sheet by means of the truing lip. The device is then drawn across the wallboard sheet, and travels in a straight line normal to the edge of the sheet due to the restriction from turning by means of the two relatively fixed rollers. Additional straight line stability may be provided by supplementary toothed wheels at each roller, which dig slightly into the paper of the wallboard sheet to provide additional grip. The result is a first cut that is essentially normal to the starting edge of the sheet and that deviates very slightly from the desired straight line, without need for additional aids, such as chalk lines, squares, guide arms, etc.

A second retractable knife blade is located at the end opposite the first blade, and is used for making the second or finishing cut on the side of the board opposite the first cut. The device may also be provided with a retractable steel tape or other measuring means, if so desired, and/or other accessories. A passage may be provided for hanging the device from a belt stud, rivet, or the like, for convenient storage if so desired.

These and other features of the present invention will become readily apparent upon further review of the following specification and drawings.

### BRIEF DESCRIPTION OF THE DRAWINGS

FIG. 1 is an environmental, perspective view of a wallboard cutting tool according to the present invention, showing its positioning at one edge of a wallboard sheet to begin a cut.

FIG. 2 is a top plan view of the present tool, showing the guide wheels and locations of the two cutting blades.

FIG. 3 is a section view along lines 3-3 of FIG. 2, showing details of the two cutting blades.

Similar reference characters denote corresponding features consistently throughout the attached drawings.

### DETAILED DESCRIPTION OF THE PREFERRED EMBODIMENT

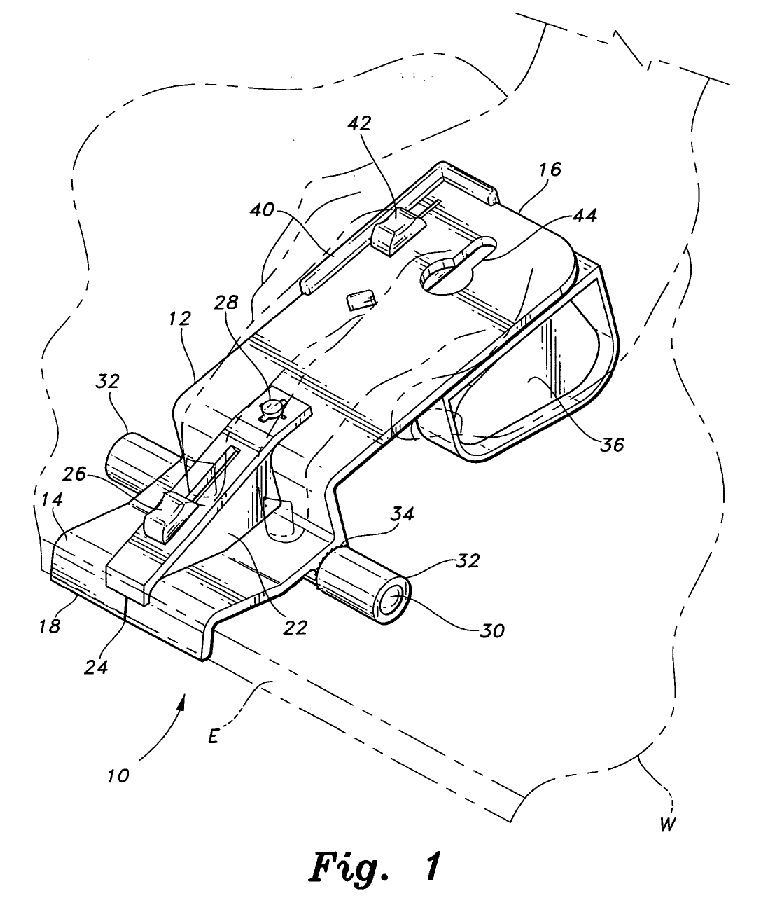

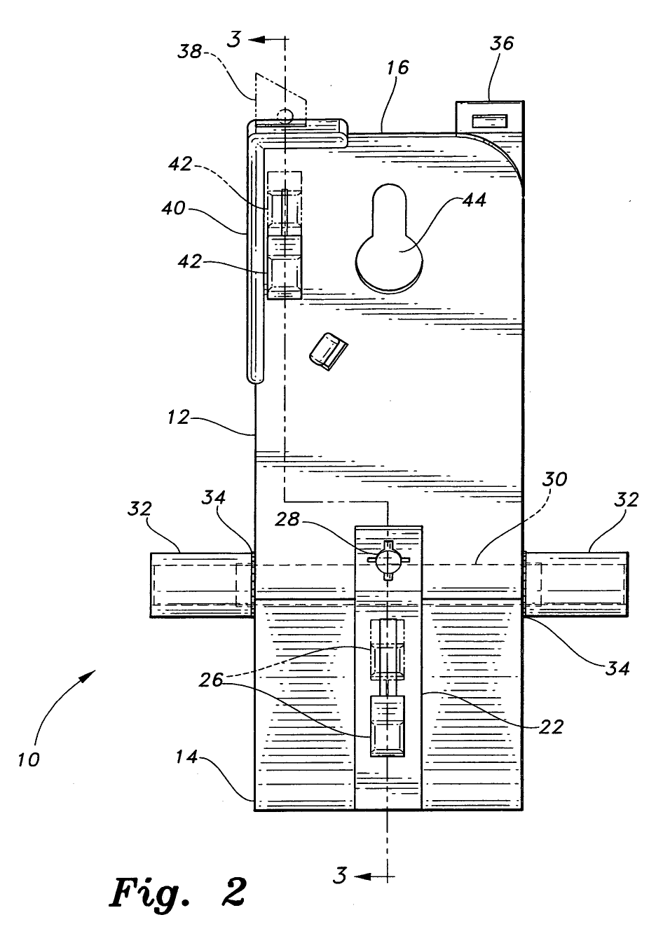

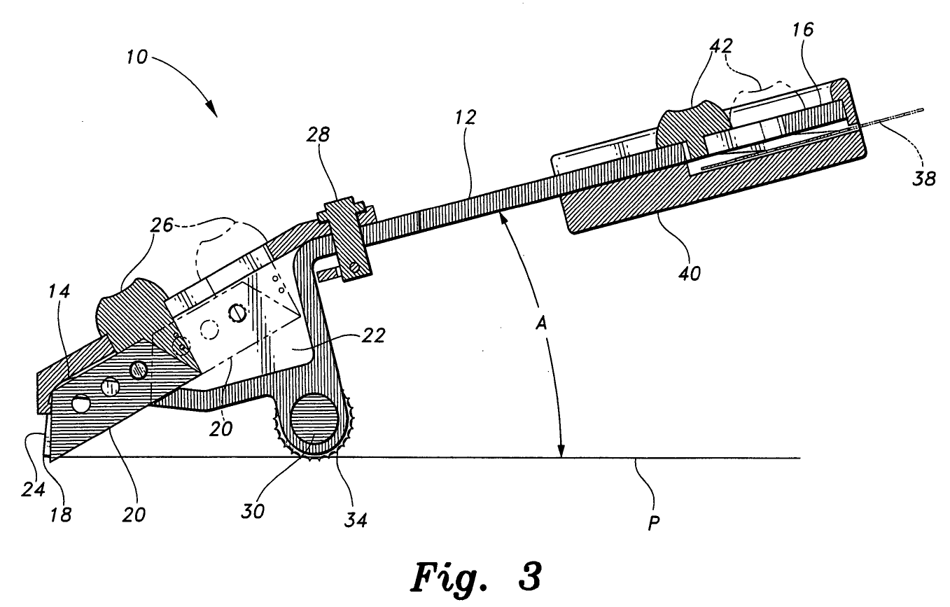

The present invention is a compact, handheld wallboard cutting tool capable of forming relatively accurate and straight cuts along or across a sheet of wallboard without need for additional accessories, such as squares, chalk lines, etc. FIG. 1 provides a perspective view of the present tool 10, with FIG. 2 providing a top plan view and FIG. 3 a side elevation view in section to show various details of the tool 10.

The cutting tool 10 comprises a hand grip frame 12, which may be formed of a generally flat sheet of durable material, e.g., steel, etc. The frame 12 is bent to provide the various functions of the present tool 10 and includes a lateral passage for a roller axle, discussed further below. The frame 12 and roller axle passage may be cut from a suitably shaped extrusion or built up from stock components, as desired.

The frame 12 includes a first end 14 having a first cutting element (e.g., tooth, blade, etc.) therein, and a second end 16 opposite the first end 14. The first end 14 includes a truing lip 18, which extends laterally across the end 14 and normal to the length of the frame 12, and which depends downwardly from the first end 14 of the frame when the tool 10 is positioned atop a sheet of wallboard in working orientation. The lip 18 is placed along one edge E of a sheet of wallboard W, generally as indicated in FIG. 1 of the drawings. When the lip 18 is in contact with the edge E of the wallboard W along the entire span of the lip, i.e., parallel to the wallboard edge E, the first cutting blade 20 (which is normal to the span of the lip 18) is disposed normal to the edge E of the wallboard sheet W, to initiate a first cut that is normal to the wallboard edge E.

The first blade 20 is most clearly shown in FIG. 3 of the drawings, with its extended position shown in solid lines and its retracted position shown in broken lines. The first blade 20 is retractably disposed within a first blade housing 22 and passes through a slot 24 centered in the truing lip 18 when the first blade 20 is extended. A first blade extension and retraction slide switch 26 operates atop the first blade housing 22 to selectively extend and retract the first blade 20 as desired, with the switch 26 shown in solid lines for a blade extended position and in broken lines for a blade retracted position in FIGS. 2 and 3. The housing 22 is removably secured atop the first end 14 of the frame 12 by a removable rivet or clasp 28, to allow the housing 22 to be opened for replacement of the first blade 20 as required. The first blade 20 preferably has a smooth, non-serrated edge, as shown in FIG. 3 of the drawings. Alternatively, a fixed tooth or similar sharp cutting element could be substituted for the retractable first blade 20, if so desired.

The frame 12 further includes a laterally disposed roller axle 30, extending across and below the frame 12 at the opposite end of the first cutting blade 20 from the truing lip 18. A roller 32 is affixed to each of the opposed ends of the solid roller axle 30, with the two rollers 32 thus being fixed relative to one another and to the axle 30. Accordingly, when one of the rollers 32 rotates, the opposite roller 32 must also rotate due to its locked relationship with its opposite member. The rollers 32 have a high traction surface for rolling across the wallboard surface without slipping. This results in the cutting tool 10 tracking straight and true across a sheet of wallboard or the like, as the device is restricted from turning due to the locked relationship of the two rollers 32. Additional grip between the tool 10 and the wallboard sheet may be provided by an externally toothed wheel 34 rotationally affixed to each end of the axle 30 and/or to each of the rollers 32. The external teeth slightly penetrate the paper covering of the wallboard to assure an even more positive grip for the tool 10.

The present wallboard cutting tool 10 is used by first extending the first cutting blade 20, and pressing the blade 20 into the edge E of the wallboard W at the desired location to begin the cut. The truing lip 18 is then squared with the edge E of the wallboard W, generally as shown in FIG. 1 of the drawings. This assures that the first blade 20 is normal to the edge E of the wallboard W, to ensure a straight cut. The roller wheels 32 are placed firmly against the surface of the wallboard W, and the tool 10 is rotated about the roller wheels 32 to raise the truing lip 18 clear of the edge E of the wallboard W. The tool 10 may then be drawn across the surface of the wallboard W, with the first blade element 20 forming a straight cut normal to the edge E of the wallboard sheet W due to the straight track maintained by the two relatively fixed roller wheels 32 and toothed wheels 34. The accuracy provided by the truing lip 18 and roller wheels 32 assures that the cut will be substantially straight and that it will deviate by no more than a fraction of an inch over several feet.

The two rollers 32 and the first cutting blade 30 and/or the lowermost edge of the truing lip 18 define a working plane P for the tool 10, as shown in FIG. 3. The rearward portion of the tool frame 12, i.e., that portion extending from the roller axle 30 to the second end 16, is angularly displaced above the working plane P by an angle A in order for the hand of the person using the tool to remain clear of the underlying wallboard panel. The portion of the frame 12 adjacent the roller axle 30 may be vertically displaced above the axle 30 as well, for greater clearance.

The cutting tool 10 is quite compact, and may include additional components and features without unduly affecting its compact nature. For example, a retractable steel measuring tape or the like may be provided adjacent the second end 16 of the frame 12, if so desired. The tape is indicated by its housing 36, as shown in FIGS. 1 and 2 of the drawings, and is conventional with the exception of its integral attachment to the second end 16 of the frame 12 of the tool 10. Alternatively, the tape could be marked to allow for the length of the frame 12, if so desired, or some other scale applied thereto.

Once the first side of the wallboard has been cut and scored, it is broken or snapped along the score line to break the material. At this point, the only thing holding the two portions together is the paper backing on the opposite side of the board from the initial cut. This paper backing is customarily cut with a utility knife or the like along the crease formed by the broken wallboard sheet along its first cut line.

Generally, the first blade 20 of the present tool 10 is not well suited for cutting through the paper backing opposite the first cut, due to the slight valley formed by the breaking of the wallboard along the score line of the first cut and the width of the truing lip 18 through which the first blade 20 extends only slightly. Additional utility may be provided by the present wallboard cutting tool 10 by including a secondary cutting blade 38 for cutting the paper backing on the side of the board opposite the first cut. This secondary blade 38 may be essentially identical to the first cutting blade 20 described further above, i.e., an off-the-shelf replaceable utility blade having a straight, non-serrated cutting edge, as shown in FIG. 2, or may have some other alternative configuration.

This secondary blade 38 is contained within a housing 40, and is controlled by a second blade slide switch 42, which operates essentially like the switch mechanism 26 of the first blade 20. This permits the second blade 38 to be retracted in order to avoid injury to the hand of the person using the present tool 10. However, the second blade 38 extends outwardly beyond the second end 16 of the frame 12 in its extended position, as shown in broken lines in FIGS. 2 and 3, and its cutting plane is oriented normal, i.e., at right angles, to the cutting plane of the first blade 20, as shown clearly in FIGS. 2 and 3 of the drawings. This permits the second blade 38 to easily reach the interior angle of the folded paper backing and cut through the backing to complete the separation of the two portions of the wallboard panel. The second blade 38 is retracted within its housing 40 by drawing the switch 42 toward the first end 14 of the frame 12, as shown in solid lines in FIGS. 1 through 3.

In conclusion, the present wallboard cutting tool 10 greatly facilitates the cutting of wallboard panels and the like in the field, and will be much appreciated by drywall mechanics and others who have occasion to cut and trim wallboard panels. The ability of the cutting tool 10 to form quite accurate cuts and scores across a wide expanse of wallboard without need for chalk lines, squares, and other guides relieves the user of the need to carry and keep track of such miscellaneous equipment generally needed with other wallboard cutting tools. Yet, the present tool is sufficiently compact and lightweight that it may be carried easily upon a tool holster, belt, or similar article. A keyhole slot 44 or the like may be provided through the frame 12 to facilitate carriage upon a button, rivet, or similar protrusion from such a holster or belt, if so desired. Accordingly, the present tool will prove to be a most versatile, capable, and desirable accessory for all who have need to work with wallboard in the construction field.

It is to be understood that the present invention is not limited to the embodiment described above, but encompasses any and all embodiments within the scope of the following claims.

I claim:

1. A handheld wallboard cutting tool, comprising:
a hand grip frame having a first end and a second end opposite the first end;
a laterally disposed truing lip extending across the first end of said frame, normal to and depending from said frame;
a first cutting element extending from the first end of said frame normal to said truing lip;
a lateral roller axle rotationally disposed opposite said first cutting element from said truing lip; and
mutually opposed first and second rollers fixed upon said roller axle.

2. The wallboard cutting tool according to claim 1, wherein:
said first cutting element and said first and second rollers define a working plane; and
THE second end of said frame is angularly displaced from the working plane.

3. The wallboard cutting tool according to claim 1, further including a retractable measuring tape integrally disposed with, and extending from, the second end of said frame, generally opposite said first cutting element.

4. The wallboard cutting tool according to claim 1, wherein:
said first cutting element comprises a cutting blade defining a cutting plane; and
the second end of said frame further includes a second cutting blade mounted thereon defining a cutting plane normal to the cutting plane of said first cutting blade.

5. The wallboard cutting tool according to claim 4, wherein said second cutting blade comprises a retractable, non-serrated cutting blade.

6. The wallboard cutting tool according to claim 1, wherein said first cutting element comprises a retractable, non-serrated cutting blade.

7. The wallboard cutting tool according to claim 1, further including an externally toothed wheel adjacent each of said rollers and rotationally affixed therewith.

8. A handheld wallboard cutting tool, comprising:
a hand grip frame having a first end and a second end opposite the first end;
a first cutting element extending from the first end of said frame normal to the first end; and
a retractable measuring tape integrally disposed with and extending from the second end of said frame opposite said first cutting element.

9. The wallboard cutting tool according to claim 8, further including:
a laterally disposed truing lip extending across the first end of said frame, depending therefrom and normal thereto;
a lateral roller axle disposed opposite said first cutting element from said truing lip; and
mutually opposed first and second rollers disposed upon said roller axle, said rollers being rotationally affixed relative to one another and to said roller axle.

10. The wallboard cutting tool according to claim 9, wherein:
said first cutting element and said first and second rollers define a working plane; and
the second end of said frame is angularly displaced from the working plane.

11. The wallboard cutting tool according to claim 9, further including an externally toothed wheel adjacent each of said rollers and rotationally affixed therewith.

12. The wallboard cutting tool according to claim 8, wherein:
said first cutting element comprises a cutting blade defining a cutting plane; and
the second end of said frame further includes a second cutting blade defining a cutting plane normal to the cutting plane of said first cutting blade.

13. The wallboard cutting tool according to claim 12, wherein said second cutting blade comprises a retractable, non-serrated cutting blade.

14. The wallboard cutting tool according to claim 8, wherein said first cutting element comprises a retractable, non-serrated cutting blade.

15. A handheld wallboard cutting tool, comprising:
a hand grip frame having a first end and a second end opposite the first end;
a first cutting blade extending from the first end of said frame, said first blade defining a cutting plane normal to the first end of said frame; and
a second cutting blade extending from the second end of said frame opposite said first cutting blade, said second blade defining a cutting plane normal to the cutting plane of said first cutting blade.

16. The wallboard cutting tool according to claim 15, further including:
a laterally disposed truing lip extending across the first end of said frame, depending therefrom and normal thereto;
a lateral roller axle disposed opposite said first cutting element from said truing lip; and
mutually opposed first and second rollers disposed upon said roller axle, said rollers being rotationally affixed relative to one another and to said roller axle.

17. The wallboard cutting tool according to claim 16, wherein:
said first cutting element and said first and second rollers define a working plane; and
the second end of said frame is angularly displaced from the working plane.

18. The wallboard cutting tool according to claim 16, further including an externally toothed wheel adjacent each of said rollers and rotationally affixed therewith.

19. The wallboard cutting tool according to claim 15, further including a retractable measuring tape integrally disposed with and extending from the second end of said frame opposite said first cutting element.

20. The wallboard cutting tool according to claim 15, wherein:
said first cutting element comprises a retractable, non-serrated cutting blade; and
said second cutting blade comprises a retractable, non-serrated cutting blade.
